(19) United States
(12) Patent Application Publication
(10) Pub. No.: US 2017/0077775 A1
(43) Pub. Date: Mar. 16, 2017

(54) Insulating Tape, Use Thereof As Electrical Insulation For Electrical Machines, Electrical Insulation, And Method For Producing The Insulating Tape

(71) Applicant: Siemens Aktiengesellschaft, Muenchen (DE)

(72) Inventors: Hermann Bödinger, Muenchen (DE); Florian Eder, Erlangen (DE); Steffen Lang, Hallerndorf (DE); Carsten Schuh, Baldham (DE)

(73) Assignee: Siemens Aktiengesellschaft, Muenchen (DE)

(21) Appl. No.: 15/125,306

(22) PCT Filed: Feb. 13, 2015
(86) PCT No.: PCT/EP2015/053084

§ 371 Date: Sep. 12, 2016

(30) Foreign Application Priority Data
Mar. 11, 2014 (DE) 10 2014 204 416.2

(51) Int. Cl. H02K 3/30; H02K 15/12; H02K 15/10

(52) U.S. Cl. CPC H02K 3/30; H02K 15/10; H02K 15/12; H02K 2203/09

(57) ABSTRACT

An insulating tape in the form of a particle composite for an electrical insulating tape, use of such insulating tape as insulation, and the production of the insulating tape are disclosed. To produce the insulating tape, electrically insulating, platelet-shaped particles are connected by an electrically insulating binder to an electrical insulating material in the form of an at least partially porous insulating tape. The insulating tape may be windable on a conductor structure when wound under exerted tension force, namely without addition of a materially additionally impeding heat flow. A thermal conductivity which is greater relative to the prior art may help prevent heat accumulation and total failures, e.g., of main insulation.

### CROSS-REFERENCE TO RELATED APPLICATIONS

This application is a U.S. National Stage Application of International Application No. PCT/EP2015/053084 filed Feb. 13, 2015, which designates the United States of America, and claims priority to DE Application No. 10 2014 204 416.2 filed Mar. 11, 2014, the contents of which are hereby incorporated by reference in their entirety.

### TECHNICAL FIELD

The invention relates to an insulating tape, use thereof as electrical insulation for electrical, particularly rotating, machines, electrical insulation and a method for producing the insulating tape.

### BACKGROUND

In rotating electrical machines such as motors or generators, the reliability of the insulation system is critically important for ensuring the safe operation of the machine. The purpose of the insulation system is to insulate electrical conductors, including wires, coils, rods, partial conductors etc., permanently from each other and from the stator core or the environment. Within a high-voltage insulation system, a distinction is made between the insulation for partial conductors, called partial conductor insulation, between the conductors and windings, which is called conductor or winding insulation, and between the conductor and earth potential in the groove and winding head area, which is referred to as the primary insulator. The thickness of the primary insulator is adapted to both the nominal voltage of the machine and to the operating and manufacturing conditions. The competitiveness of future energy generation systems, their distribution and use, depends to a critical degree on the materials used and the technologies that are employed to insulate them. The fundamental problem with such electrically loaded insulators is due to a phenomenon known as partial discharge-induced erosion, with the formation of “treeing” channels, which ultimately result in the electric breakdown of the insulator. This barrier to the propagation of treeing channels is currently achieved by using mica, which is used in the form of mica paper. For this purpose, mica particles with an aspect ratio of at least 10 are used to manufacture mica paper. This means that the ratio between the length and width on the one side and the platelet thickness on the other side is at least 10. Because of the large surface area created thereby, the particles can be aligned with each other and are densely packed, so that a mechanically resilient mica paper is formed. The binding forces generated by this interaction between the surfaces are directly related to the contact surfaces of adjacent particles. This results in thermodynamic terms from the interaction between the primary particles due to Van der Waals forces or hydrogen bridge bonds. Consequently, a flexible paper is obtained that can be readily wrapped around electrical conductors and can be impregnated with a reactive resin, and at the same time includes an effective barrier to treeing channels. The particles must also have good resistance to the partial discharges that occur constantly while rotating machines are in operation. The inorganic structure of the mica means that it inherently possesses high resistance to partial discharge. In order to enhance its mechanical strength, the mica paper is applied to a glass or polyester fabric carrier, and finally converted into a composite material. This is done by impregnating the paper with a liquid, reactive polymer and curing it in a subsequent process step. Insulating tapes are already known that comprise for example a fabric or mica material, wherein an adhesive bonds the two components in such manner that a “corona shielding tape” is created. Among other applications, this is used to provide electrical insulation for electrical conductors in high-voltage machines and high-voltage generators. The thermal conductivity of the normally used mica paper impregnated with epoxy resins and mounted on a glass or polyester fabric as carrier material is about 0.2-0.25 W/mK at room temperature. The insulating material produced in this way thus exhibits both good electrical properties and good heat insulation properties. Consequently, heat builds up when large rotating machines are in operation. Because of the poor thermal conductivity of the mica insulation, only a little of the heat that is generated in the copper conductor can be dissipated to the steel of the stator. This heat accumulation is particularly prevalent in the middle section of the generator. Moreover, temperature rises due to partial discharges caused by in homogeneities and irregularities in the primary insulator may occur locally, causing the resin component of the primary insulator to age. When aging is sufficiently advanced, a ground fault may develop in the copper conductors and thus also lead to a complete failure of the electrically rotating machine.

Depending on their performance class, generators are cooled with air, hydrogen or water. However, as a consequence of the poor thermal conductivity of the primary insulator, which is <0.3 W/mK, the Joule heat in the copper wire cannot be conducted away to stator core quickly even with cooling. Depending on the heat generated in the electrical conductor, the cooling means must be changed from air to hydrogen, or in the case of even greater amounts of heat generated in the most powerful generators, even this hydrogen cooling must be supplemented with a water cooling system. Most attempts to improve the thermal conductivity of the insulation have adopted the conventional approach of introducing heat conducting particles, such as BN, diamond, Al₂O₃ or TiO₂. But since these materials have practically no positive effect on the electric strength of the insulation system due to their dimensions or physical properties, they can only be used in combination with mica. A company by the name of Roll-Isola Holding Ltd., Edenstraβe 20, CH-8045 Zürich has developed a mica tape which is furnished with a layer containing boron nitride. In this case, a maximum thermal conductivity of 0.5 W/mK at room temperature was achieved. The disadvantage of this known mica tape is that the layer thickness of the tape is increased, and the boron nitride exhibits anisotropic thermal conductivity, which significantly limits a use in practice. Boron nitride has low thermal conductivity perpendicularly to the insulation system.

Mica shielding tapes that use aluminum oxide as the carrier fabric are described in patent EP 1 643 511. The disadvantage of this is that the fabric does not contribute to the electric strength of the insulation, and for this reason the volume fraction of fabric in the insulation is limited, because otherwise the electric strength is limited excessively.

It is also known from US 2007/0141324 that ribbon aluminum oxide is used as a direct substitute for mica. There are many applications that occupy themselves with introducing thermally conductive particles into the impregnating resin or the mica, but none of them is able to function effectively without the use of mica, and consequently they only succeed in enabling a small increase in thermal conductivity.

It is further known to add thermally conductive particles for VPI processes. US 2005/0274450 describes a process for compacting resin-impregnated insulating tapes to which particles with excellent heat conducting properties, such as silicon oxide, aluminum oxide and other substances have been added in a volume fraction from 5 to 60% by volume.

U.S. Pat. No. 7,776,392 describes a composite insulating tape that contains highly thermally conductive components, wherein said components are present in the resin mixture and penetrate the composite tape.

WO 2007/114876 describes a method for producing a tape with highly conductive particles. These are used to impregnate the rear of a composite tape, such that at least 1% of the thermally conductive particles contained in the resin penetrate the fabric.

WO 2008/091489 describes an insulating tape having a multilayer platelet structure. In this case, the insulation consists of a mixture of mica platelets and boron nitride platelets.

US 2012/0009408 describes a pre-impregnated, highly thermally conductive mica paper on which a meso-micro mixture of highly thermally conductive platelets, preferably consisting of boron nitride, is arranged preferably between the fabric and the mica layer.

All the aforementioned methods are limited exclusively to applications in “resin-rich technology” and are thus unsuitable for a VPI process.

EP 12 715 081 and WO 2011/138273 A1 describe the manufacture of a readily wound tape consisting of ribbon Al₂O₃, which is designed to completely replace the mica paper used as standard and which features substantially greater thermal conductivity than mica. However, the material costs therefor are many times greater, about 100 times greater than the mica paper used conventionally. In both of these patent applications, the manufacture and use of an aluminum oxide tape is described as a replacement for the conventional mica material with the aim of enhancing thermal conductivity in the primary insulator. To this end, an aqueous solution of aluminum oxide particles is spread on a glass fabric in a tape casting process, then dried and coated with a tape varnish to increase its strength. The completed tape can now be used to wrap the primary insulator. However, in identical structures in which the mica is replaced by aluminum oxide the thermal conductivity of the primary insulator can only be doubled. It is not possible to achieve thermal conductivity values much higher than 0.5 W/mK with that solution approach.

### SUMMARY

One embodiment provides an insulating tape in the form of a particle composite for an electrical insulating tape, wherein electrically insulating platelet-shaped particles are connected by means of an electrically insulating binder to an electrically insulating material in the form of an at least partially porous insulating tape; wherein the insulating tape is windable on a conductor structure when wound under an exerted tensile force.

In one embodiment, the insulating tape has sufficient tensile strength and flexibility for winding without additives having heat insulating effects.

In one embodiment, an insulating paper is first made from the electrically insulating material, and from this a tape was prepared from the insulating paper as insulating tape.

In one embodiment, the insulating tape is affixed detachably to a temporary carrier tape for winding, particularly by means of a laminating roller.

In one embodiment, an insulating paper is first made from the electrical insulating material, then a tape is prepared from the insulating paper and is affixed detachably to the temporary carrier tape as insulating tape.

In one embodiment, the use of an insulating tape as disclosed above includes winding the insulating tape by applying it to the conductor structure.

In one embodiment, the use of the insulating tape includes winding the insulating tape by applying it to the conductor structure, wherein the temporary carrier tape is separated from the insulating tape in a direction parallel to the application.

In one embodiment, the temporary carrier tape is separated from the insulating tape after the application.

In one embodiment, the temporary carrier tape is separated from the insulating tape before the application.

In one embodiment, the temporary carrier tape is pulled off the insulating tape continuously during the application.

In one embodiment, the insulating tape is wound onto the conductor structure in an offset overlapping manner.

In one embodiment, as the insulating tape is wound around the conductor structure, an overlap of 40% to 60% is created each time with the existing insulating tape.

In one embodiment, the binder is removed from the insulating tape after the winding.

In one embodiment, the insulating tape is impregnated after the winding.

Another embodiment provides an electrical insulation, e.g., primary insulation, for an electrical machine, e.g., a rotating machine, wherein an insulating tape as disclosed above is wound onto or around a conductor structure of the machine in an offset, overlapping manner after a use as disclosed above.

Another embodiment provides a method for producing an electrical insulating tape as disclosed above, wherein the platelet-shaped particles are metal oxide platelets or mica platelets.

In one embodiment, the metal oxide platelets are aluminum oxide platelets.

In one embodiment, the binder is polymer-based.

In one embodiment, the binder is an epoxidized Novolack system.

In one embodiment, an insulating paper is first made from the electrically insulating material, and from this a tape is prepared from the insulating paper as insulating tape.

In one embodiment, the insulating tape is applied and detachably affixed to a temporary carrier tape.

In one embodiment, the insulating tape is film cast or film fed as an organic or aqueous slurry system onto the temporary carrier tape and then dried.

In one embodiment, the insulating tape is assembled to form a winding tape before the winding operation.

### BRIEF DESCRIPTION OF THE DRAWINGS

Example aspects and embodiments of the invention are described below with reference to the drawings, in which:

FIG. 1 shows an embodiment of a conventional primary insulator;

FIG. 2 is a further view of the conventional primary insulator;

FIG. 3 shows an embodiment of a primary insulator according to the invention;

FIG. 4 shows an embodiment of a winding operation according to the invention;

FIG. 5 shows an embodiment of a method according to the invention for producing an insulating tape according to the invention;

FIG. 6 shows an embodiment of a use according to the invention of an insulating tape according to the invention.

### DETAILED DESCRIPTION

Embodiments of the present invention provide an electrical insulation for electrical, e.g., rotating machines in such manner that the electrical resistance is high and the thermal conductivity of the insulation is high, particularly greater than 0.5 W/mK, and aging is effectively slowed. It should be capable of insulating electrical machines with nominal output particularly in the kilowatt or megawatt range.

In particular, electrically induced aging may be effectively rendered slower.

Some embodiments provide an insulating tape in the form of a particle composite is suggested for the electrical insulating tape, wherein electrically insulating platelet-shaped particles are connected by means of an electrically insulating binder to form an electrical insulating material in the form of an at least partially porous insulating tape and the insulating tape is windable on a conductor structure when wound under an exerted tensile force.

Other embodiments provide a use of the insulating tape is provided, wherein winding of the insulating tape is carried out by applying it directly to the conductor structure.

Other embodiments provide an electrical insulation, e.g., primary insulation, for an electrical machine, e.g., a rotating machine may be produced, wherein an insulating tape according to the invention was wound onto or around a conductor structure of the machine in an offset, overlapping manner after a use according to according to the invention.

Other embodiments provide a method for producing an insulating tape according to the invention is suggested, in which the platelet-shaped particles are metal oxide platelets or mica platelets.

It is suggested to use a novel, windable insulating tape of platelet-shaped particles that may be thoroughly impregnated and which is able to perform its intended function effectively without the glass fiber fabric used conventionally. This fabric serves solely to improve winding properties and mechanical stability during operation. Consequently, an insulating tape according to the invention consists predominantly of the platelet-shaped particles and a binder, but is at least partly porous, and may thus also be impregnated.

Since conventional fabric/plastic intermediate layers are no longer necessary, it is possible to effectively increase the overall thermal conductivity of the electrical insulation, which may particularly be a primary insulator. The reason for this is a connection in series of thermal resistors, particularly in a radial direction, which indicates that the total thermal conductivity of a primary insulator or insulation is determined by the largest thermal resistor in the serial circuit.

If an insulation, particularly a primary insulator, is constructed without the use of a fabric, as suggested according to the invention, thermal conductivity is determined solely by the plastic layer with the platelet-shaped particles. This can result in an increase by a multiple factor of the thermal conductivity in the overall insulation system.

According to embodiment, the insulating tape may already have sufficient tensile strength and flexibility for winding without additives having heat insulating effects.

According to a further embodiment, an insulating paper may first be made from the electrically insulating material, and from this a tape may be prepared from the insulating paper as insulating tape.

According to a further embodiment, the insulating tape may be affixed detachably to a temporary carrier tape for winding.

According to a further embodiment, an insulating paper may first be made from the electrical insulating material, then a tape may be prepared from the insulating paper and this may be affixed detachably to the temporary carrier tape as insulating tape.

According to a further embodiment the insulating tape may be wound by applying it to the conductor structure, wherein the temporary carrier tape is separated from the insulating tape in a direction parallel to the application.

According to a further embodiment, the temporary carrier tape may be separated from the insulating tape after the application.

According to a further embodiment, the temporary carrier tape may be separated from the insulating tape before the application, and particularly immediately before the application.

According to a further embodiment, the temporary carrier tape may be pulled off the insulating tape continuously during the application.

According to a further embodiment, the insulating tape may be wound onto the conductor structure in an offset overlapping manner. This means that the insulating tape only covers a partial area of the insulating tape already applied during each winding.

According to a further embodiment, when the insulating tape is wound around the conductor structure, an overlap of particularly 50% is created.

According to a further embodiment, the binder may be removed from the insulating tape after the winding.

According to a further embodiment, the insulating tape may be impregnated after the winding.

According to a further embodiment, the platelet-shaped particles may be metal oxide platelets or mica platelets.

According to a further embodiment, the metal oxide platelets may be aluminum oxide platelets.

According to a further embodiment, the binder may be polymer-based.

According to a further embodiment, the binder may be an epoxidized Novolack system.

According to a further embodiment, an insulating paper may first be made from the electrically insulating material, and from this a tape is prepared from the insulating paper as insulating tape.

According to a further embodiment, the insulating tape may be applied and detachably affixed to a temporary carrier tape.

According to a further embodiment, the insulating tape may be film cast or film fed as an organic or aqueous slurry system onto the temporary carrier tape and then dried.

According to a further embodiment, the insulating tape may be assembled to form a winding tape before winding operation.

FIG. 1 shows an example of a conventional primary insulator or main insulating system. Primary insulator 7 is arranged between an inner electrode 9 and an outer electrode 11. It consists of a plurality of layers of Al₂O₃/plastic on glass fabric/plastic. Reference character 7a designates an Al₂O₃/plastic layer, and reference character 7b designates a glass fabric/plastic layer to which each layer 7a has been applied. In the cross section according to FIG. 1, a plurality of layers 7a and 7b are combined to create primary insulator 7, which results from the winding of layers 7a and 7b. The fabric/plastic intermediate layers 7b are arranged between the actual electrical insulating layers 7a, and these impede the greater total thermal conductivity of the primary insulator. The reason for this is the serial connection of thermal resistors, which indicates that the total thermal conductivity of the primary insulator is defined by the greatest thermal resistance in the serial circuit. According to this conventional embodiment, these are the glass fabric/plastic layers, which have a thermal conductivity of about 0.2 W/coolant. In contrast, an aluminum oxide-plastic layer without fabric has thermal conductivity several times greater, in the order of >0.8 W/mK. The serial circuit represented in FIG. 1 would provide a total thermal conductivity of 0.3 to 0.4 W/mK due to the different thermal conductivities of the individual layers.

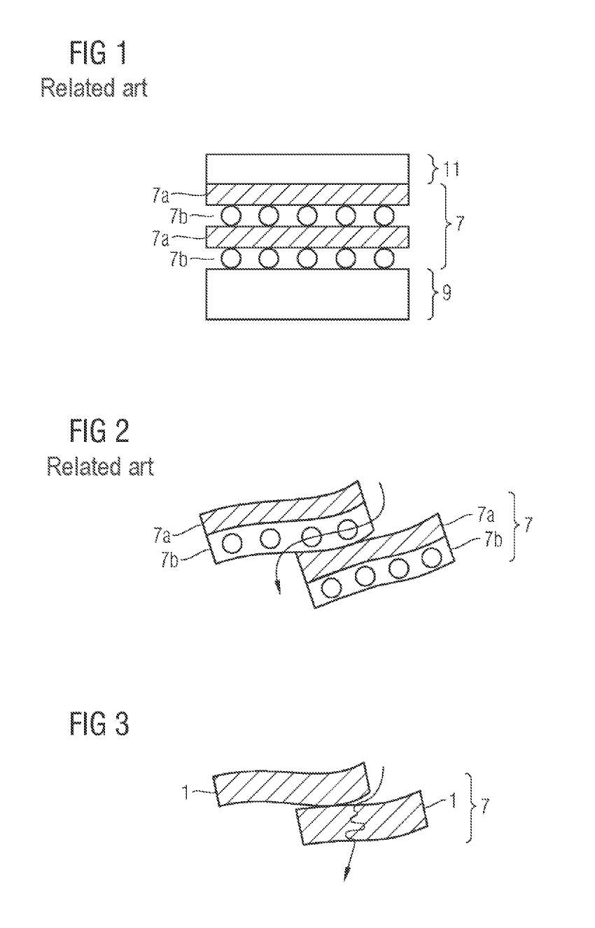

FIG. 2 shows an example of a conventional primary insulator, in which conventional layers are wound around each other. FIG. 2 shows a conventional layer sequence of an Al₂O₃ plastic layer 7a on a glass fabric/plastic intermediate layer 7b. FIG. 2 shows insulating tape with a 50% overlap. The thermal conductivity of glass fabric/plastic layer 7b is poor, and it does not contribute to improved resistance to electrical erosion. The reason for this is that emerging treeing channels are able to propagate perpendicularly to the primary insulator without a longer path (as with platelet-shaped metal oxide). When the primary insulator 7 is wound, the overlap between tape windings is typically 50%. If a winding tape with glass fabric support 7b is used, glass fabric/plastic area 7b represents the component that is significantly susceptible to erosion, with the result that a treeing channel that forms here is able to propagate in a straight line on the glass fabric 7b without much resistance. Area 7a, which includes platelet-shaped filler material, is more resistant to erosion and is thus bypassed.

FIG. 3 shows an embodiment of an insulation according to the invention, particularly a primary insulator. A fabric-free plastic layer with platelet-shaped particles, particularly Al₂O₃ particles is used, wherein a conventional glass fabric/plastic layer 7b which is susceptible to erosion is not required, and the erosion resistance of the overall primary insulator is increased for the same total layer thickness.

The consequent elongation of the treeing channels has the effect of increasing the average operating life of the primary insulator and reducing the likelihood that the entire generator will fail. The decisive factor in the electrical erosion of the polymer insulating system is the kinetic energy of the electron avalanche. This is directly proportional to the scale of the damage to the plastic insulation and the speed with which it spreads. With a constant field strength, as is present here, this kinetic energy is determined by the acceleration path in the gas-phase dielectric, for example in a pore or a previously formed erosion channel, that is to say the path along which the field acts on the electrons without the decelerating influence of an obstacle in the form of a solid. With the modified structure of primary insulator 7, these long acceleration paths are now avoided, since all areas of primary insulator 7 are filled with partial discharge-resistant platelet particles that lengthen the treeing channels. This slows the propagation of erosion damage and in turn lengthens the operating life of insulation 7. In the case of the glass fabric-free winding according to the invention, this erosion-susceptible partial area no longer exists. The erosion path must advance through the aligned platelet structure, which involves a significantly longer distance. This improves erosion resistance decisively, and in turn contributes to a longer operating life of the total insulation system, as is shown in FIG. 3.

FIG. 3 shows an embodiment of a use according to the invention of an electrical insulating tape 1 according to the invention. The insulating tape 1 represented in FIG. 3 is an aluminum oxide tape, such as is used as primary insulation 7 for electrical insulation of electrical, particularly rotating machines, particularly permanent electrical high-voltage insulation, particularly between a conductor and an earth potential in a groove and winding head. The aluminum oxide tape is wound about an area of the machine, particularly in the groove and winding head, in such manner that the windings overlap by 50%, that is to say the adjacent windings are offset with respect to each other by half the width of insulating tape 1.

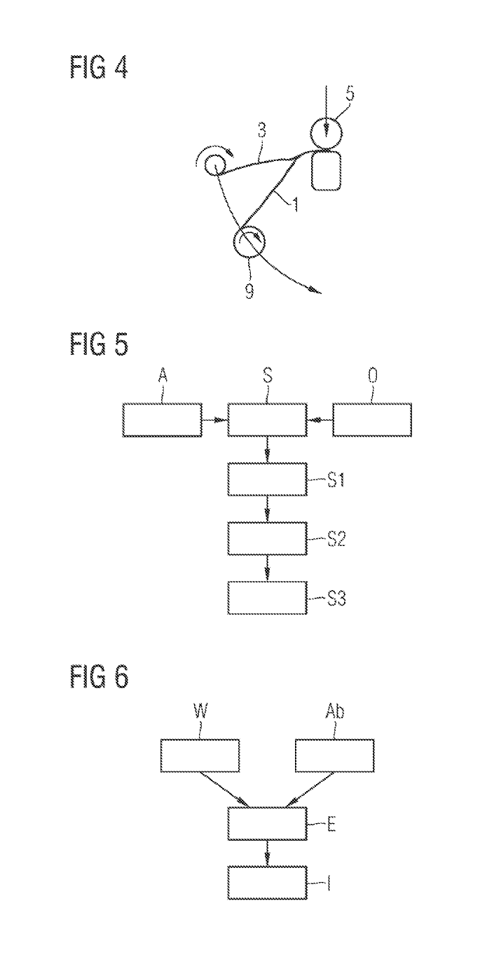

FIG. 4 shows an embodiment of a winding operation according to the invention. After passing through a laminating roller 5, the insulating tape 1, which is detachably affixed to a carrier tape 3, insulating tape 1 may be wound onto the conductor structure in the form of a film, after having been separated from carrier tape 3. FIG. 4 shows how the insulating tape is wound round the conductor structure, for example a conductor structure 9. In the same way, the carrier tape 3 may be wound up and reused correspondingly. When insulating tape 1 is wound around conductor structure 9, the combination of insulating tape 1 on carrier tape 3 must have sufficient tensile strength for winding by machine which is carried out under conditions of mechanical pretension. The combination must also be windable and have a corresponding flexibility. During winding, it must be ensured particularly that no air is trapped between the individual windings between the applied foil or the applied insulating tape 1.

FIG. 5 shows an embodiment of a method according to the invention for producing an insulating tape 1 having sufficient flexibility for winding, wherein sufficient tensile strength is provided temporarily by a carrier tape 3. In a first step S1, a green insulating tape 1 is produced by film casting or film feeding an organic or aqueous slurry system S on a carrier tape 3 which lends the system sufficient mechanical stability for winding. In this process, an inorganic substance A may include filler materials and for example platelet-shaped Al₂O₃ and an organic substance O dissolved in a solvent may include binders, dispersants and/or plasticizers. In a second step S2, drying may be performed. In a third step S3, the components are combined to form a winding tape.

Alternatively, according to FIG. 5 a further method for producing a porous particle composite for an electrical insulating tape 1 according to the invention may include the following steps: Step S1 consists of mixing a dispersion of platelet-shaped particles, a carrier fluid and a functionalizing agent that is spread throughout the carrier fluid and constitutes a mass fraction of the carrier fluid in the dispersion equal to a predetermined mass ratio relative to the mass fraction of the particles; preparing a base deposit by sedimentation of the dispersion, by which the platelet-shaped particles are arranged plane-parallel, substantially in layers in the base deposit; and removing the carrier fluid from the base deposit. In a second step S2, energy is introduced into the base deposit to overcome the activation energy of the chemical reaction of the functionalizing agent with the particles which forms the particle composite from the base deposit by coupling the particles via the functionalizing agent, wherein the mass ratio is determined beforehand such that the particle composite has a porous structure.

One possible production variant for an insulating tape 1 according to the invention, consisting of aluminum oxide platelets or mica platelets, for example, and an epoxidized Novolack system may thus be film casting or film feeding starting with an organic or aqueous slurry system on a carrier tape 3 that ensures mechanical stability until the winding operation.

FIG. 6 shows an embodiment of a use according to the invention of an insulating tape 1 according to the invention. During a winding operation W of insulating tape 1 onto an electrical conductor with mechanical pretension, at the same time an operation is carried out to continuously remove Ab the temporary carrier tape 3 from the green insulating tape 1 directly after the incremental application of the green insulating tape 1 to a conductor structure. Then a winding of the still green insulating tape 1 remains on the conductor structure that is to be insulated. This may be followed by a step E of debinding the winding of the green insulating tape. Finally, a step I of impregnating the winding of the green insulating tape may be carried out.

In the winding operation, the carrier tape 3 may be removed continuously from the insulating tape 1 as soon as said tape has been applied successively to the conductor structure 9. In this way, de facto only a winding operation of the actual insulating tape 1 takes place, so that only “active” insulating material, which is also capable of being completely impregnated remains on the conductor 9 that is to be insulated. The green film tape thus obtained may optionally be debound after the winding, to increase the proportion of open and thus readily impregnable porosity in the material. A shaped film tape may be referred to as a green film tape, the film tape after debinding may be referred to as brown film tape.

What is claimed is:

1. An insulating tape, comprising:
an at least partially porous insulating tape comprising:
an electrically insulating material; and
electrically insulating platelet-shaped particles connected by an electrically insulating binder to the electrically insulating material to form the at least partially porous insulating tape;
wherein the insulating tape is windable on a conductor structure when wound under an exerted tensile force.

2. The insulating tape of claim 1, wherein the insulating tape has sufficient tensile strength and flexibility for winding without additives having heat insulating effects.

3. The insulating tape of claim 1, wherein the tape is prepared from an insulating paper as insulating tape.

4. The insulating tape of claim 1, wherein the insulating tape is detachably affixed to a temporary carrier tape for winding by a laminating roller.

5. The insulating tape of claim 4, wherein the tape is prepared from an insulating paper made from the electrically insulating material and wherein the tape is detachably affixed to the temporary carrier tape as insulating tape.

6. A method of forming a conductor structure of an electrical machine, the method comprising:
forming an insulating tape comprising an at least partially porous insulating tape comprising:
an electrically insulating material; and
electrically insulating platelet-shaped particles connected by an electrically insulating binder to the electrically insulating material to form the at least partially porous insulating tape; and
winding the insulating tape onto the conductor structure of the electrical machine.

7. The method of claim 6, comprising, in connection with the winding of the insulating tape onto the conductor structure, separating the insulating tape from a temporary carrier tape.

8. The method of claim 7, wherein the temporary carrier tape is separated from the insulating tape after winding the insulating tape onto the conductor structure.

9. The method of claim 7, wherein the temporary carrier tape is separated from the insulating tape before winding the insulating tape onto the conductor structure.

10. The method of claim 6, comprising pulsing the temporary carrier tape off of the insulating tape continuously during the winding of the insulating tape onto the conductor structure.

11. The method of claim 6, wherein the insulating tape is wound onto the conductor structure in an offset overlapping manner.

12. The method of claim 11, wherein as the insulating tape is wound around the conductor structure in an offset overlapping manner with an overlap of 40% to 60% between consecutive windings.

13. The method of claim 6, including removing the binder from the insulating tape after the winding.

14. The method of claim 6, comprising impregnating the insulating tape after the winding.

15. An electrically insulated system, comprising:
an electrical machine comprising a conductor structure,
an insulating tape wound onto or around the conductor structure of the electrical machine in an offset, overlapping manner, the insulating tape comprising an at least partially porous insulating tape comprising:
an electrically insulating material; and
electrically insulating platelet-shaped particles connected by an electrically insulating binder to the electrically insulating material to form the at least partially porous insulating tape;

16. The insulating tape of claim 1, wherein the platelet-shaped particles are metal oxide platelets or mica platelets.

17. The insulating tape of claim 16, wherein the metal oxide platelets are aluminum oxide platelets.

18. The insulating tape of claim 16, wherein the binder is polymer-based.

19. The insulating tape of claim 18, wherein the binder is an epoxidized Novolack system.

20-21. (canceled)

22. The insulating tape of claim 16, wherein the insulating tape is film cast or film fed as an organic or aqueous slurry system onto the temporary carrier tape and then dried.

23. (canceled)
